(19) United States
(12) Patent Application Publication
(10) Pub. No.: US 2013/0063547 A1
(43) Pub. Date: Mar. 14, 2013

(54) MULTIPLE-SITE DRAWN-IMAGE SHARING APPARATUS, MULTIPLE-SITE DRAWN-IMAGE SHARING SYSTEM, METHOD EXECUTED BY MULTIPLE-SITE DRAWN-IMAGE SHARING APPARATUS, PROGRAM, AND RECORDING MEDIUM

(71) Applicants: Yuuji Kasuya, Kanagawa (JP); Tadashi Araki, Kanagawa (JP); Keiji Ohmura, Kanagawa (JP)

(72) Inventors: Yuuji Kasuya, Kanagawa (JP); Tadashi Araki, Kanagawa (JP); Keiji Ohmura, Kanagawa (JP)

(21) Appl. No.: 13/698,497

(22) PCT Filed: May 10, 2011
(86) PCT No.: PCT/JP2011/061127

§ 371 Date: Nov. 16, 2012

(30) Foreign Application Priority Data
May 17, 2010 (JP) 2010-113102
Mar. 4, 2011 (JP) 2011-047669

(51) Int. Cl. H04N 7/14

(52) U.S. Cl. 348/14.08; 348/E07.077

(57) ABSTRACT

A multiple-site drawn-image sharing apparatus is disclosed that causes images drawn on thawing objects provided at multiple sites to be shared between the drawing objects. The apparatus includes an image storage unit configured to store the images drawn at the respective sites; an image synthesizing unit configured to superimpose and synthesize the images stored in the image storage unit in a manner so as not to include the images drawn at transmission destinations; and an image transmission unit configured to transmit the images synthesized by the image synthesizing unit to the respective sites.

### TECHNICAL FIELD

The present invention relates to a multiple-site drawn-image sharing device that causes drawn images drawn on white boards or the like as drawing objects to be shared between multiple sites, a multiple-site drawn-image sharing system, a method executed by the multiple-site drawn-image sharing apparatus, a program, and a recording medium.

### BACKGROUND ART

In recent years and continuing to the present, telephone conferences, video-phone conferences, or the like have become pervasive due, for example, to the globalization of corporate activities and an increase in collaborative operations between multiple sites. Since the telephone conferences are held mainly based on audio signals, they are sometimes insufficient from the viewpoint of recording and comprehension. Further, the video-phone conferences have become popular since information can be conveyed in real time and perfectly. However, they give rise to problems that dedicated hardware devices are required, installation cost is likely to become high, and the arrangement of images on display screens is difficult at respective sites. Further, in order to link multiple sites to each other at the same time, there arises a problem in bearing a cost for constructing a video conference system.

Patent Document 1 discloses a remote conference support system for displaying, when conferences are held at remote conference rooms, conference information drawn on the white boards of the respective conference rooms on the white boards of the other parties. To this end, the remote conference support system is configured to have two projectors that are installed in each of remote places and project projection images and have a server that transmits original images that should be projected to the two projectors. Each of the two projectors has an image pickup unit that picks up a drawn image drawn on a screen onto which the projection images are projected and has a transmission unit that transmits the drawn image picked up by the image pickup unit to the server. The server has a synthesizing unit that synthesizes the drawn image received from one of the two projectors with the original image and a transfer unit that transmits the image synthesized by the synthesizing unit to the other of the two projectors.

However, if the remote conference support system is used at plural remote places, i.e., if it is used at multiple sites, it is required to transmit images corresponding to the number of sites where the images are received, thereby giving rise to a problem that processing load at each of the sites increases. Further, in this case, each of the sites is required to have a dedicated unit adaptable to the multiple sites.

As described above, there arise the problems in the conventional art that the dedicated unit adaptable to the multiple sites is required to share drawn images drawn on the white boards as drawing objects between the multiple sites and the processing load at each of the multiple sites increases.

Patent Document 1: JP-A-2005-203886

### DISCLOSURE OF INVENTION

The present invention has been made in view of the above problems and may have an object of providing a multiple-site drawn-image sharing apparatus that is capable of causing drawn images drawn at multiple sites to be shared without increasing the processing load of each of the sites and facilitates the sharing of the drawn images. The present invention may also have an object of providing a multiple-site drawn-image sharing system, a method executed by the multiple-site drawn-image sharing apparatus, a program, and a recording medium.

According to an aspect of the present invention, there is provided a multiple-site drawn-image sharing apparatus that causes images drawn on drawing objects provided at multiple sites to be shared between the drawing objects. The apparatus includes an image storage unit configured to store the images drawn at the respective sites; an image synthesizing unit configured to superimpose and synthesize the images stored in the image storage unit in a manner so as not to include the images drawn at transmission destinations; and an image transmission unit configured to transmit the images synthesized by the image synthesizing unit to the respective sites.

According to another aspect of the present invention, there is provided a multiple-site drawn-image sharing system having a multiple-site drawn-image sharing apparatus that causes images drawn on drawing objects provided at multiple sites to be shared between the drawing objects and having clients that extract only information drawn at own sites from the images drawn on the drawing objects. The multiple-site drawn-image sharing apparatus includes an image storage unit configured to store the images drawn at the respective sites; an image synthesizing unit configured to superimpose and synthesize the images stored in the image storage unit in a manner so as not to include the images drawn at transmission destinations; and an image transmission unit configured to transmit the images synthesized by the image synthesizing unit to the respective sites.

According to still another aspect of the present invention, there is provided a method executed by a multiple-site drawn-image sharing apparatus that causes drawn images drawn at two or more remote sites to be shared. The method includes storing the images drawn at the respective sites; superimposing and synthesizing the stored images in a manner so as not to include the images drawn at transmission destinations; and transmitting the synthesized images to the respective sites.

### BRIEF DESCRIPTION OF DRAWINGS

FIG. 1 is a view showing a first embodiment of a multiple-site drawn-image sharing system 100 according to the present invention;

FIG. 2 is a view showing the function blocks of a multiple-site drawn-image sharing apparatus 200 according to an embodiment;

FIG. 3 is a flowchart of processing executed by the multiple-site drawn-image sharing apparatus 200 according to the embodiment;

FIG. 4 is a schematic view of image processing according to a first synthesizing method used in the embodiment;

FIG. 5 is a schematic view of the image processing according to a second synthesizing method used in the embodiment;

FIG. 6 is a flowchart of processing in which the multiple-site drawn-image sharing apparatus 200 according to the embodiment accumulates own-site images transmitted from respective sites;

FIG. 7 is a flowchart of processing executed by the multiple-site drawn-image sharing apparatus 200 in a case where the first synthesizing method according to the embodiment is used; and

FIG. 8 is a flowchart of processing executed by the multiple-site drawn-image sharing apparatus 200 in a case where the second synthesizing method according to the embodiment is used.

### BEST MODE FOR CARRYING OUT THE INVENTION

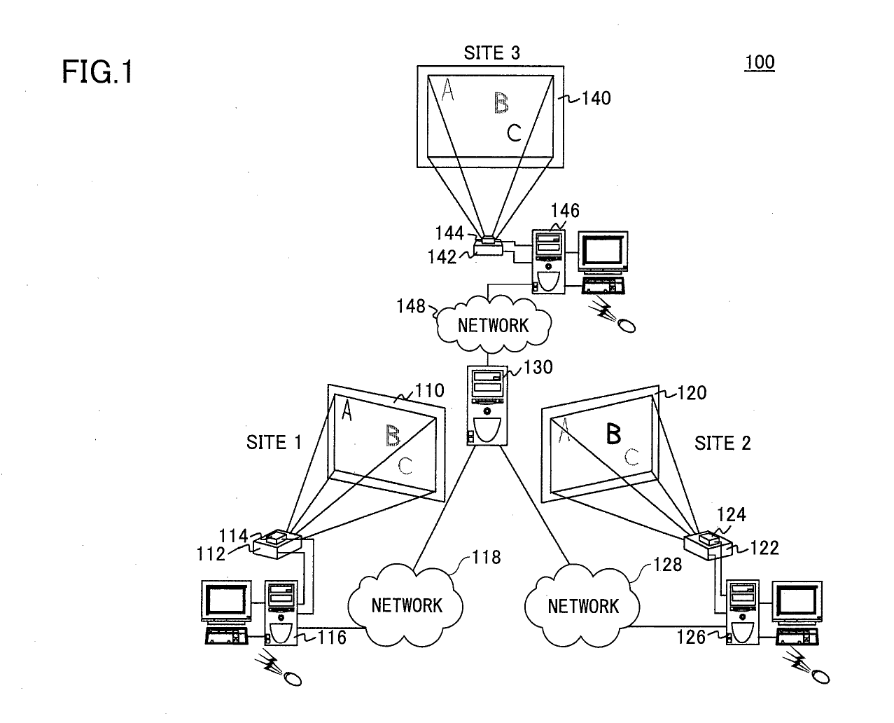

Hereinafter, a description is made of embodiments of the present invention, but the present invention is not limited to the embodiments. FIG. 1 shows a first embodiment of a multiple-site drawn-image sharing system 100 (hereinafter simply referred to as an apparatus 100) according to the present invention. In the embodiment shown in FIG. 1, the system 100 causes images drawn on white boards 110, 120, and 140 serving as drawing objects to be shared between sites 1, 2, and 3. Note that the number of the sites is not limited.

In the site 1 are installed the white board 110, a visualization device 112 that projects images transmitted from the sites 2 and onto the white board 110 so as to be displayed, and a photographing device 114 that captures the images of the white board 110 as a whole. In FIG. 1, among those displayed on the white board 110 of site 1, “A” is the image drawn at the site 1, and “B” and “C” are the images drawn at the sites 2 and 3, respectively. At the site 1, these images are provided as display images displayed by the visualization device 112. In the embodiment, the visualization device 112 is realized by a projector that projects image data onto the white board so as to be visualized. However, the visualization device 112 may be configured in such a manner that display images generated by synthesizing images of the other sites are displayed by a display function imparted to the white board.

In the site 1 is further installed an information processing apparatus such as a personal computer 116 (hereinafter referred to as a PC 116). The PC 116 controls projection by the visualization device 112, capturing of images to be shared with the other sites by the photographing device 114 such as a shooting device and a digital video camera, transmission of images drawn at the site 1 to the sites 2 and 3, or the like.

In the embodiment, the PC 116 serves as a client with respect to a server 130. The PC 116 acquires the images of the site 1, which are drawn at the site 1, from the captured images of the white board 110 and transmits them to the server 130 connected via a network 118. Further, the PC 116 receives display images constituted by the images of the other sites other than the site 1 from the server 130 and causes the visualization device 112 to project them.

The photographing device 114 can be realized by a digital camera, a video camera, or the like. The photographing device 114 acquires the images of the white board 110 as moving images in, for example, a JPEG format, a MOVINGJPEG format, or an H.264 format, and sequentially transmits image files to the PC 116. The white boards 110, 120, and 140 have marks at their four corners or the like to share relative sizes of images to be shared between the remote sites. The marks are used to perform alignment when the visualization device 112, a visualization device 122, and a visualization device 142 project images, and manually or automatically correspond to differences in size or the like of the white boards 110, 120, and 140 between the remote sites.

The sites 2 and 3 have hardware arrangement similar to that of the site 1 described above. The visualization device 122 installed in the site 2 projects the images of the sites 1 and 3 onto the white board 120, and a photographing device 124 captures the images of the white board 120 and transmits them to a PC 126. The PC 126 acquires the images of the site 2 including the image “B” drawn at the site 2 and transmits them to the server 130 via a network 128.

The visualization unit 142 installed in the site 3 projects the images of the sites 1 and 2 onto the white board 140, and a photographing device 144 captures the images of the white board 140 and transmits them to a PC 146. The PC 146 acquires the images of the site 3 including the image “C” drawn at the site 3 and transmits the images of the site 3 to the server 130 via a network 148 to be projected at the sites 1 and 2.

At the site 1, the images “B” and “C” drawn at the sites 2 and 3, respectively, transmitted to the server 130 are projected as display images via the projector 112 onto the white board 110 where the image “A” of the own-site 1 is drawn. Thus, the images “A,” “B,” and “C” are displayed on the white board 110 as superimposed images.

Further, at the site 2, the images “A” and “C” drawn at the sites 1 and 3, respectively, are projected as display images via the projector 122 onto the white board 120 where the image “B” of the own-site 2 is drawn. Thus, the images “A,” “B,” and “C” are displayed on the white board 120 as superimposed images. Moreover, at the site 3, the images “A” and “B” drawn at the sites 1 and 2, respectively, are projected as display images via the projector 142 onto the white board 140 where the image “C” of the own-site 3 is drawn. Thus, the images “A,” “B,” and “C” are displayed on the white board 140 as superimposed images. Consequently, in FIG. 1, it is shown that the same images are shared between the sites 1, 2, and 3.

In the embodiment shown in FIG. 1, the server 130 manages a client list for identifying the currently-connected PCs 116, 126, and 146 to perform multiple-site image sharing. In order to cause images to be shared between the PCs 116, 126, and 146 registered in the client list or between more PCs, the server 130 performs image processing to generate display images to be displayed at the respective sites. Note that in the following embodiment, images transmitted from other sites via the server 130 and displayed in such a manner as to be projected by the visualization units are referred to as display images. Further, images photographed by the photographing device 114 or the like are referred to as images of sharing regions. Moreover, difference images between the images of the sharing regions and the display images are referred to as own-site images. Furthermore, each of the sites performs processing for extracting the own-site images and then transmits them to the server 130. The processing for extracting the own-site images can be implemented by the technology described in Patent Document 1 or the like.

The server 130 can have either a microprocessor based on CISC architecture, such as PENTIUM™, XEON™, CELERON™, CORE 2 DUO™, and PENTIUM™ compatible chips or a microprocessor based on RISC architecture such as POWERPC™ in a single core format or a multi-core format. Further, the server 130 is controlled by an operating system such as WINDOWS™ 200X, UNIX™, and LINUX™, and generates display images using a server program such as CGI, servlet, APACHE, and IIS (Internet Information Server) written in a programming language such as C, C++, JAVA™, Perl, and Ruby.

The PCs 116, 126, and 146 can be personal computers or workstations, and their microprocessors (MPUs) may include any known single core processor or multi-core processor. Further, PCs 116, 126, and 146 may be controlled by any known operating system such as WINDOWS™, UNIX™, LINUX™, and MAC OS. Further, in order to access the server 130, the PCs 116, 126, and 146 can have browser software such as Internet Explorer™, Mozilla™, Opera™, and FireFox™, or can be installed as a client-server system based on a legacy configuration. In the embodiment shown in FIG. 1, the PCs are installed as the client-server system, and the server 130 makes it possible to share images by sequentially unicasting display images generated for each of the sites with reference to an own-managing client list.

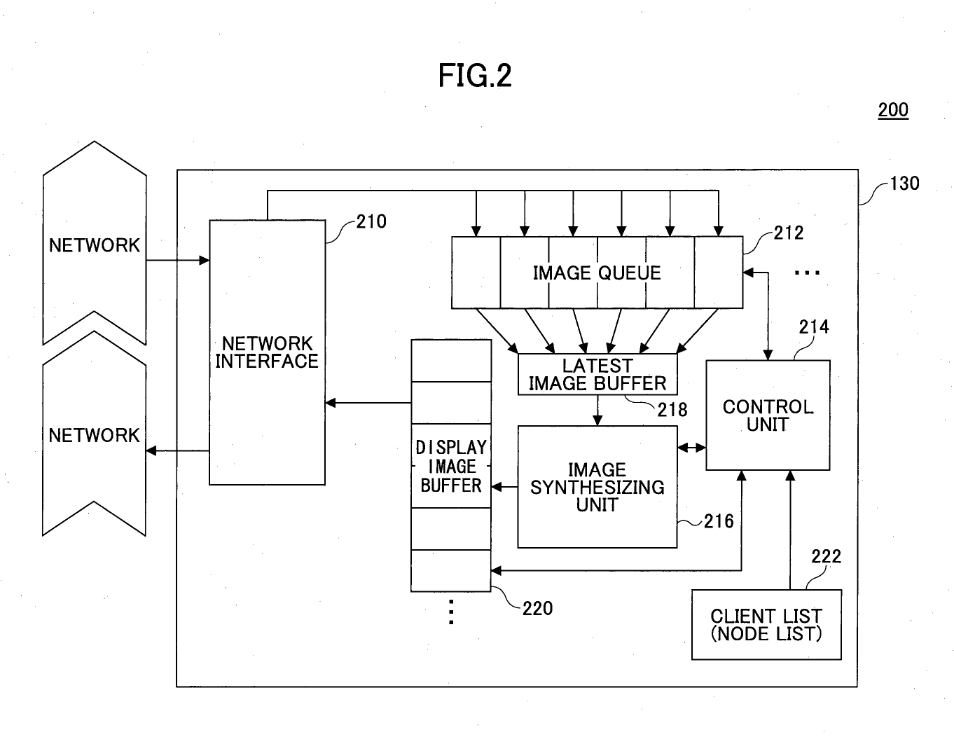

FIG. 2 shows the function blocks of a multiple-site drawn-image sharing apparatus 200 according to the embodiment. Note that in FIG. 2, the server 130 is caused to serve as the multiple-site drawn-image sharing apparatus 200 for convenience by execution of software using the hardware resources of the server 130. The server 130 interactively communicates with the clients such as the PCs 116, 126, and 146 via the networks to transmit display images to the clients and receives own-site images from the clients.

The multiple-site drawn-image sharing apparatus 200 is configured to include a network interface 210 for establishing network connections, an image queue 212, and an image synthesizing unit 216. The network interface 210 is a unit that transmits and receives images to and from the clients 116, 126, and 146 via the networks 118, 128, and 148 such as the Internet and a LAN. The image queue 212 is an image storage unit that secures memory regions such as image RAMs corresponding to the number of the clients registered in a client list 222 and registers the own-site images of the clients transmitted via the networks in the memory regions allocated to the respective clients. Note that in the embodiment, the client list 222 can be prepared using the IP addresses, handle names, or the like of the clients, and can be sequentially generated using information such as the IP header of the PC that issues an image sharing request.

The respective images temporarily stored in the image queue 212 are moved to a latest image buffer 218 for processing in which the image synthesizing unit 216 generates display images to be transmitted to the respective clients. The image synthesizing unit 216 reads the own-site images of the respective sites from the latest image buffer 218, integrates these images to generate synthesized images used by the clients as display images, and stores the synthesized images in a display image buffer 220 secured so as to be associated with the clients.

The synthesized images can be essentially generated in such a manner that the own-site images transmitted from the respective sites are subjected to registration matching and then layer-synthesizing. When performing the registration matching, the image synthesizing unit 216 can synthesize the images based on, for example, the upper left coordinates (0, 0) of the images to be superimposed. The image synthesizing unit 216 can also use lower left coordinates, upper right coordinates, and lower right coordinates as reference points. Further, when synthesizing the images using the received respective own-site images, the image synthesizing unit 216 can employ, by comparing the pixel luminance values of the respective own-site images at a position on the same image, a minimum pixel luminance value as the pixel luminance value of the synthesized images at the position.

The display images to be transmitted to the respective sites can be generated in such a manner that the own-site images of the clients to which the display images are to be transmitted are excluded from the generated synthesized images described above and then the resulting images are layer-synthesized. Alternatively, in a state where all the own-site images are synthesized in advance, the display images can be generated as difference images between the display images and the own-site images of the clients to which the display images are to be transmitted. This image processing is described in detail below. Here, the registration matching refers to the alignment of the images in vertical and horizontal directions, and the layer-synthesizing refers to a method for forming the synthesized images by calculation using pixel values at the same position.

A control unit 214 is a function unit that manages the data processing and the transmission of display images between the image queue 212, the image synthesizing unit 216, the latest image buffer 218, and the display image buffer 220. As in the case of other functions of the server 130, the control unit 214 is caused to serve as the function unit of the server 130 in cooperation with the image RAMs or the like when a central processing unit (CPU) included in the server 130 executes a program.

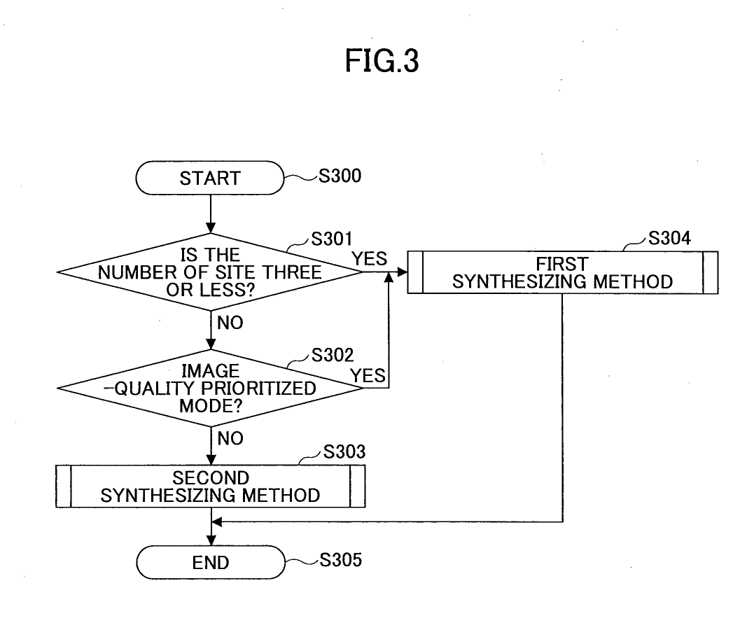

FIG. 3 shows the flowchart of processing executed by the multiple-site drawn-image sharing apparatus 200 according to the embodiment. The processing shown in FIG. 3 serves as a service or a daemon after the multiple-site drawn-image sharing apparatus 200 is invoked, and is repeatedly executed until the service or the daemon is completed. In step S300, the processing starts. In step S301, a determination is made as to whether the number of the clients registered in the client list 222, i.e., the number of the sites is less than or equal to three. If the number of the sites is less than or equal to three (YES), the processing branches to step S304 to generate display images according to a first synthesizing method. In step S305, the generated display images are transmitted to the clients and the processing ends.

On the other hand, if the number of the sites is greater than or equal to four in step S301 (NO), the processing moves to step S302 to determine whether an image-quality prioritized mode is established. If the image-quality prioritized mode is established (YES), the processing moves to step S304 to generate display images according to the first synthesizing method. Then, the generated display images are transmitted. Thus, the processing ends in step S305. On the other hand, if the image-quality prioritized mode is not established in step S302 (NO), the processing moves to step S303 to generate display images according to a second synthesizing method. Note that the first synthesizing method is a method in which plural own-site images are sequentially added to be synthesized with each other. Further, the second synthesizing method is a method in which own-site images accumulated until the processing starts are integrated to generate synthesized images and then the own-site images not required by the clients are subtracted from the synthesized images to generate display images.

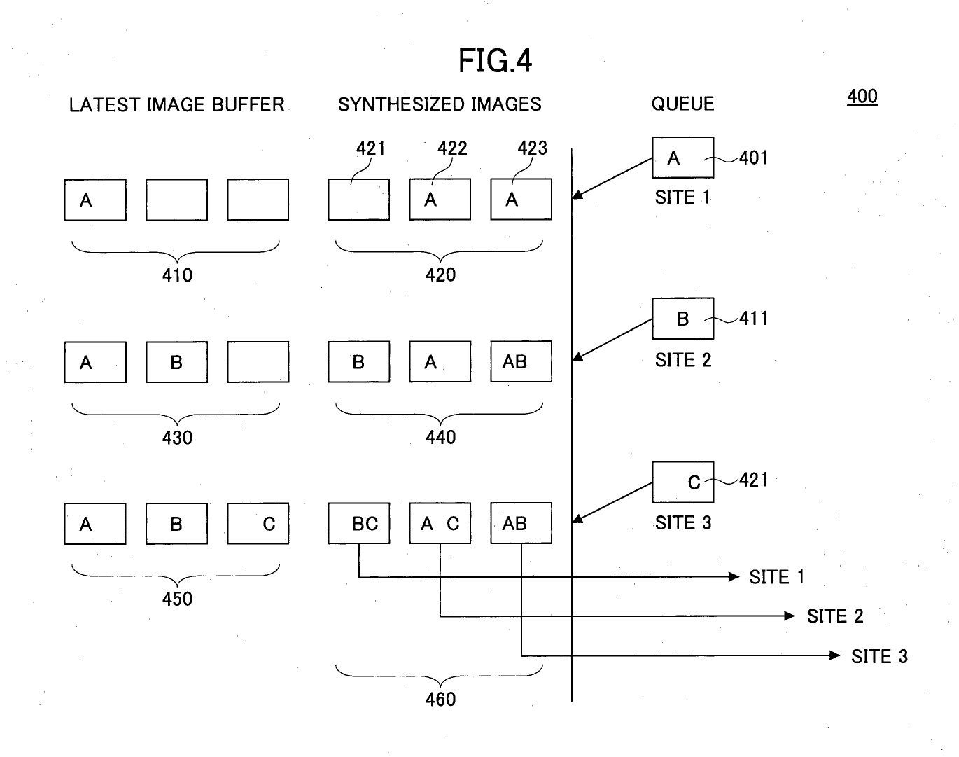

FIG. 4 is a schematic view of the image processing according to the first synthesizing method used in the embodiment. For convenience, it is assumed that images are shared between the sites 1, 2, and 3. Own-site images transmitted from the respective clients are temporarily registered in the latest image buffer 218. When an own-site image “A” 401 is transmitted from the site 1 to the image queue 212, the latest image buffer 218 becomes a data structure 410. According to the first synthesizing method, the images of the sites 2 and 3 other than the site 1 that has transmitted the own-site image “A” are synthesized and registered in the display image buffer 220. Therefore, the synthesized images are registered in the display image buffer 220 as a data structure 420. If the own-site images have not been transmitted from the other sites at this stage, images 421, 422, and 423 constituting the data structure 420 are transmitted to the sites 1, 2, and 3, respectively, as display images.

On the other hand, if own-site images “B” 411 and “C” 421 have been transmitted from the sites 2 and 3, respectively, at synthesizing timing, the images corresponding to the clients that have transmitted the own-site images are specified to exclude the own-site images not required at the synthesizing timing. Then, the available own-site images are sequentially synthesized, and display images are registered in the display image buffer 220 as data structures 440 and 460. Here, the specification of the images can be made by reference to the transmission sources of the received images. Consequently, according to the first synthesizing method, the following relationships are established: “calculation amount O=(n2−n)” and “memory use amount=2n” where the number of the sites is n. The first synthesizing method increases the memory use amount almost in proportion to the square of the number of the sites, but high quality can be expected since the calculation of image differences are not required. Note that in the processing of the multiple-site drawn-image sharing apparatus 200, the latest image buffer 218 is not always required in a case where the processing is executed after the images from the clients registered in the client list 222 are transmitted.

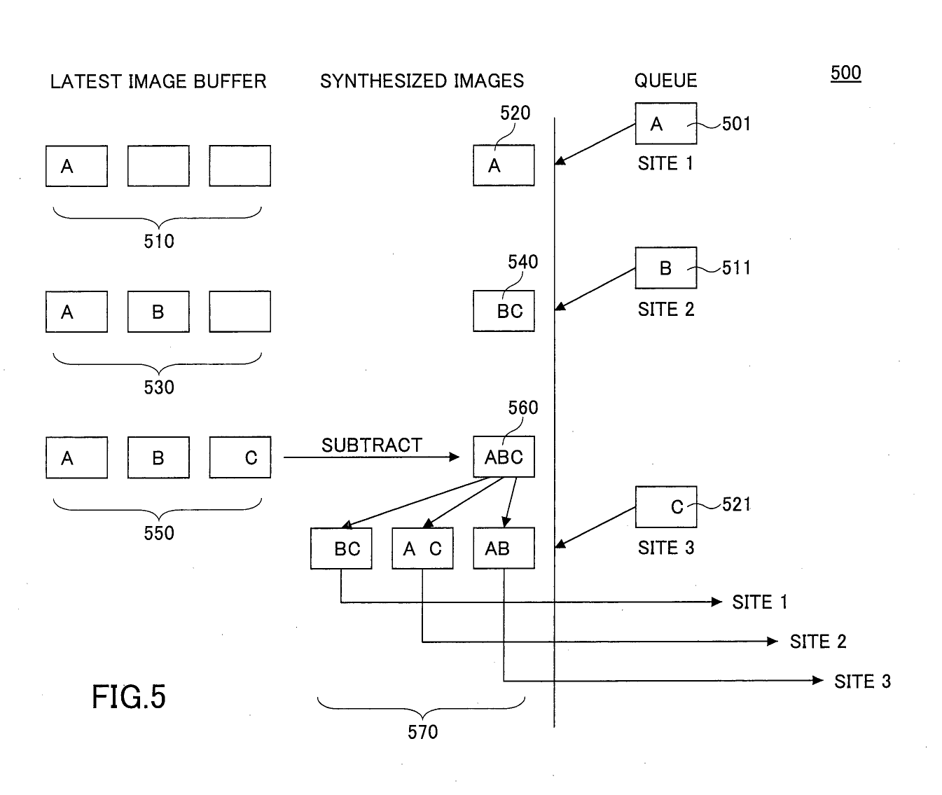

FIG. 5 is a schematic view of the image processing according to the second synthesizing method used in the embodiment. As in the case of FIG. 4, it is assumed that images are shared between the three sites 1, 2, and 3 for convenience. The second synthesizing method described in FIG. 5 imports own-site images “A” 501, “B” 511, and “C” 521 transmitted from the sites 1, 2, and 3, respectively, into the latest image buffer 218 and generates data structures 510, 530, and 550.

When the new images are registered in the latest image buffer 218, they are regarded as integrated images 520, 540, and 560, respectively, and finally integrated as an image in which the own-site images of all the sites are synthesized. Then, the own-site images of the sites registered in the latest image buffer 218 to which the images are to be transmitted are subtracted from the integrated image 560 in which the own-site images of all the sites are integrated, thereby generating difference images indicated by a data structure 570. The difference images are registered in the memory regions allocated to the respective sites corresponding to destinations in the display image buffer 220 and then distributed to the respective sites.

In order to generate the difference image, a difference in luminance value between the integrated image 560 and the image stored in the latest image buffer 218 is calculated at a certain position on the same image. The value obtained by subtracting the difference from the possible maximum value of the luminance value can be set as the luminance value of the difference image at the position. For example, if the maximum value of luminance is 255 in the embodiment, the luminance value of the difference image at a certain position is calculated by “255−(a−b)” assuming that the luminance value of an integrated image at the position on an image is “a” and the luminance value of an image stored in the latest image buffer is “b.”

The second synthesizing method is more effective than the first synthesizing method in terms of consuming hardware resources since it establishes the following relationships “calculation amount O=(2n)” and “memory use amount=(n+2).” However, image quality such as color balance may be degraded since the second synthesizing method generates difference images. Therefore, the second synthesizing method is preferably used in a case where the number of the sites is large and priority is not placed on image quality.

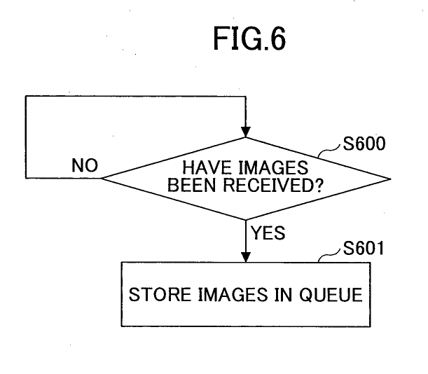

Hereinafter, referring to FIGS. 6 through 8, a description is made in detail of display image generation processing according to the embodiment. FIG. 6 is a flowchart of processing in which the multiple-site drawn-image sharing apparatus 200 according to the embodiment accumulates own-site images transmitted from respective sites. In step S600, the processing in FIG. 6 starts and determines whether the own-site images have been received from the respective clients. If the own-site images have not been received (NO), the processing is on standby for receiving the own-site images. On the other hand, if the own-site images have been received (YES), the processing moves to step S601 to store the images in the image queue 212 to enable the following processing. Note that the own-site images can be repeatedly accumulated until the own-site images from all the clients registered in the client list are received, or can be sequentially transmitted to the image queue 212 at the time at which the images are received.

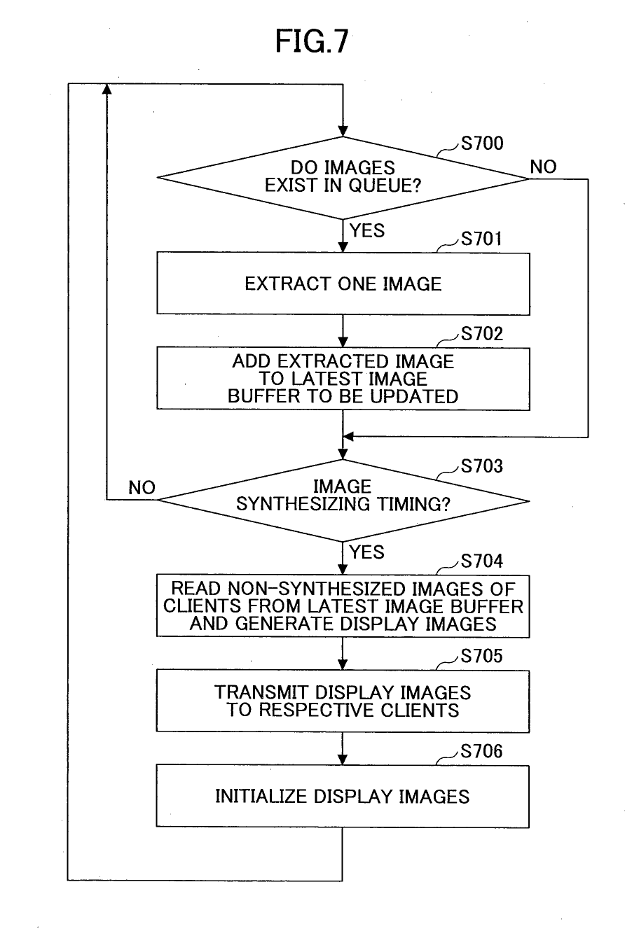

FIG. 7 is a flowchart of processing executed by the multiple-site drawn-image sharing apparatus 200 in a case where the first synthesizing method according to the embodiment is used. In step S700, a determination is made as to whether images exist in the image queue 212. If the images exist in the image queue 212 (YES), one of the images is extracted from the image queue 212 in step S701. Then, in step S702, the extracted image is added to the latest image buffer. Thus, the latest image buffer is updated. On the other hand, if no image exists in the image queue 212 (NO), the processing branches to step S703 to determine whether image synthesizing timing has come.

In step S703, a determination is made as to whether the image synthesizing timing has come. If the image synthesizing timing has not come (NO), the processing returns to step S700 to determine again whether images exist in the image queue 212. On the other hand, if the image synthesizing timing has come in step S703 (YES), own-site images that have not been synthesized in step S704, i.e., the own-site images that have not been synthesized at a previous image synthesizing timing are read from the latest image buffer 218 to generate synthesized images. On this occasion, without being subjected to subtraction processing or the like, the synthesized images are generated as display images excluding the own-site images that are to be transmitted to corresponding clients.

In step S705, the generated synthesized images (=display images) are transmitted from the display image buffer 220 to the respective clients via the networks. Then, in step S706, the images in the display image buffer 220 are flashed to return the processing to step S700. Thus, the processing of steps S700 through S706 is repeatedly executed until no image to be processed exists. Further, if no image to be processed exists in the image queue 212 in step S700, the processing branches to step S703 to be on standby for the image synthesizing timing.

According to the embodiment, when the display images of all the sites are stored in the display image buffer 220, the control unit 214 can cause the display image buffer 220 to transmit the display images to the respective clients. According to another embodiment, the control unit 214 can cause the display image buffer 220 to sequentially transmit the display images of the sites stored in the display image buffer 220 to the clients.

According to still another embodiment, the control unit 214 can cause the display image buffer 220 to transmit the display images to the respective clients when certain time elapses since the starting of the image synthesizing processing. In this case, the control unit 214 causes, when the display images of all the sites are not stored in the display image buffer 220, the image synthesizing unit 216 to generate display images that have not been stored in the display image buffer 220 using latest images previously stored in the latest image buffer 218.

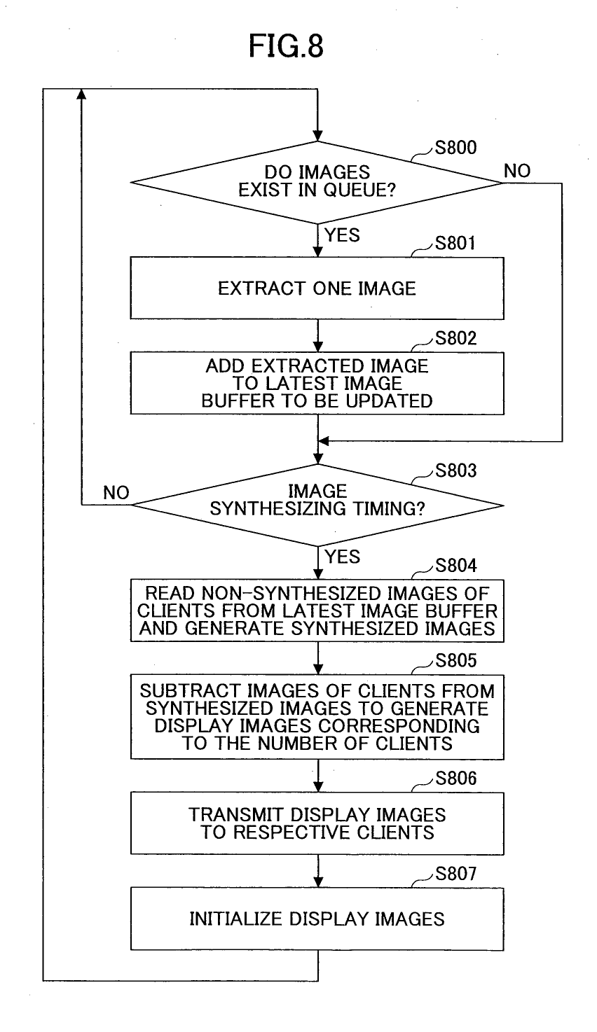

FIG. 8 is a flowchart of processing executed by the multiple-site drawn-image sharing apparatus 200 in a case where the second synthesizing method according to the embodiment is used. In step S800, a determination is made as to whether images exist in the image queue 212. If the images exist in the image queue 212 (YES), one of the images is extracted from the image queue 212 in step S801. Then, in step S802, the extracted image is added to the latest image buffer. Thus, the latest image buffer is updated. On the other hand, if no image exists in the image queue 212 in step S800 (NO), the processing branches to step S803.

In step S803, a determination is made as to whether the image synthesizing timing has come. If the image synthesizing timing has not come (NO), the processing returns to step S800 to determine again whether images exist in the image queue 212. On the other hand, if the image synthesizing timing has come in step S803 (YES), own-site images that have not been synthesized in step S804, i.e., the own-site images that have not been synthesized at a previous image synthesizing timing are read from the latest image buffer 218 to generate synthesized images. On this occasion, the synthesized images are generated as images obtained by synthesizing the own-site images of all the sites linked to each other at that time.

In step S805, the own-site images registered in the latest image buffer 218 are subtracted from the generated synthesized images to generate display images corresponding to the number of clients, and the generated display images are stored in the display image buffer 220. In step S806, the display images are transmitted to the respective clients via the network. In step S807, the images in the display image buffer 220 are flashed to return the processing to step S800. Thus, the processing of steps S800 through S807 is repeatedly executed until no image to be processed exists. Further, if no image to be processed exists in the image queue 212 in step S800, the processing branches to step S803 as in the case of FIG. 7 to be on standby for the image synthesizing timing. Here, the image synthesizing timing may be generated at uniform intervals to obtain a desired frame rate. For example, the image synthesizing timing may be generated for every 0.1 second to obtain 10 frames per second.

According to the embodiment, when the display images of all the sites are stored in the display image buffer 220, the control unit 214 can cause the display image buffer 220 to transmit the display images to the respective clients. According to another embodiment, the control unit 214 can cause the display image buffer 220 to sequentially transmit the display images of the sites stored in the display image buffer 220 to the clients.

According to still another embodiment, the control unit 214 can cause the display image buffer 220 to transmit the display images to the respective clients after a certain time elapses since the starting of the image synthesizing processing. In this case, the control unit 214 causes, when the display images of all the sites are not stored in the display image buffer 220, the image synthesizing unit 216 to generate display images that have not been stored in the display image buffer 220 using latest images previously stored in the latest image buffer 218.

As described above, according to the embodiments of the present invention, it is possible to integrate the images independently drawn at the multiple sites and share them between the sites with a minimum time difference and the continuity of the images.

The above functions of the embodiments can be implemented by an apparatus-installable program written in an object-oriented programming language or the like such as C++, Java™, JavaScript™, Perl, and Ruby. The program can be stored in an apparatus-readable recording medium such as a hard disk unit, a CD-ROM, a MO, a flexible disk, an EEPROM, and an EPROM for distribution, and can be transmitted via networks in a form executable by other apparatuses.

The present application is based on Japanese Priority Application Nos. 2010-113102 filed on May 17, 2010 and 2011-047669 filed on Mar. 4, 2011 with the Japan Patent Office, the entire contents of which are hereby incorporated by reference.

1-13. (canceled)

14. A multiple-site drawn-image sharing apparatus that causes images drawn on drawing objects provided at multiple sites to be shared between the drawing objects, the apparatus comprising:
an image storage unit configured to store the images drawn at the respective sites;
an image synthesizing unit configured to superimpose and synthesize the images stored in the image storage unit in a manner so as not to include the images drawn at transmission destinations; and
an image transmission unit configured to transmit the images synthesized by the image synthesizing unit to the respective sites.

15. The multiple-site drawn-image sharing apparatus according to claim 14, wherein
the image synthesizing unit generates synthesized images by superimposing a position of an image drawn at a first site on positions of images drawn at sites other than the first site.

16. The multiple-site drawn-image sharing apparatus according to claim 15, wherein
the image synthesizing unit generates the synthesized images by replacing with a minimum value a pixel luminance value at a same position of the image drawn at the first site and the images drawn at the sites other than the first site.

17. The multiple-site drawn-image sharing apparatus according to claim 14, the apparatus further comprising:
a latest image buffer configured to store latest images drawn at the respective sites.

18. The multiple-site drawing-image sharing apparatus according to claim 14, wherein
the image synthesizing unit specifies the image drawn at the first site stored in the latest image buffer to synthesize the images other than the image drawn at the first site stored in the latest image buffer.

19. The multiple-site drawing-image sharing apparatus according to claim 14, wherein
the image synthesizing unit integrates the images received from all the sites to generate an integrated image, and
generates difference images between the integrated image and the images stored in the latest image buffer to thereby generate the synthesized images.

20. The multiple-site drawing-image sharing apparatus according to claim 14, the apparatus further comprising:
an image synthesizing method determination unit configured to determine a synthesizing method of the image synthesizing unit based on a number of the sites and image quality.

21. The multiple-site drawing-image sharing apparatus according to claim 14, wherein
the image transmission unit transmits the synthesized images to the respective sites at a time at which the synthesized images of all the sites to be transmitted are generated.

22. The multiple-site drawing-image sharing apparatus according to claim 14, wherein
the image transmission unit sequentially transmits the synthesized images to the respective sites when the synthesized images to be transmitted are generated.

23. The multiple-site drawing-image sharing apparatus according to claim 14, wherein
the image transmission unit transmits the synthesized images to the respective sites when a certain time elapses since starting of image synthesizing processing.

24. The multiple-site drawing-image sharing apparatus according to claim 23, wherein
the image synthesizing unit generates, if the synthesized images of all the sites are not generated when the certain time elapses since the starting of the image synthesizing processing, the synthesized images using latest images previously stored in the latest image buffer, and
the image transmission unit transmits the synthesized images.

25. A multiple-site drawn-image sharing system having a multiple-site drawn-image sharing apparatus that causes images drawn on drawing objects provided at multiple sites to be shared between the drawing objects and having clients that extract only information drawn at own sites from the images drawn on the drawing objects, the multiple-site drawn-image sharing apparatus comprising:
an image storage unit configured to store the images drawn at the respective sites;
an image synthesizing unit configured to superimpose and synthesize the images stored in the image storage unit in a manner so as not to include the images drawn at transmission destinations; and
an image transmission unit configured to transmit the images synthesized by the image synthesizing unit to the respective sites.

26. A method executed by a multiple-site drawn-image sharing apparatus that causes drawn images drawn at two or more remote sites to be shared, the method comprising:
storing the images drawn at the respective sites;
superimposing and synthesizing the stored images in a manner so as not to include the images drawn at transmission destinations; and
transmitting the synthesized images to the respective sites.
